(19) United States
(12) Patent Application Publication
(10) Pub. No.: US 2008/0190632 A1
(43) Pub. Date: Aug. 14, 2008

(54) Percussion Hammer and/or Drill Hammer Comprising a Handle Which Can be Guided in a Linear Manner

(75) Inventors: Rudolf Berger, Grunwald (DE); Wolfgang Schmid, Munchen (DE)

Correspondence Address: BOYLE FREDRICKSON S.C., 840 North Plankinton Avenue, MILWAUKEE, WI, 53203, US

(73) Assignee: WACKER CONSTRUCTION EQUIPMENT AG, Munchen (DE)

(21) Appl. No.: 10/596,298

(22) PCT Filed: Nov. 24, 2004
(86) PCT No.: PCT/EP2004/013338

§ 371 Date: Jun. 8, 2006

(30) Foreign Application Priority Data
Dec. 10, 2003 (DE) 103 57 758.0

(51) Int. Cl. B25D 17/04

(52) U.S. Cl. 173/162.2

(57) ABSTRACT

The invention relates to a percussion hammer and/or a drill hammer comprising a hammer housing, a handle which is preferably embodied as a handle cover and which can be displaced in a working direction (A) in relation to the hammer housing and which surrounds at least one part of the hammer housing. The hammer also comprises a guiding device which is used to guide the handle cover in a linear manner in relation to the hammer housing. The hammer is characterized in that the guiding device comprises a rolling body device which is active between the hammer housing and the handle cover. The rolling body device ensures that the handle cover is guided in a stable manner, with respect to tilting, in relation to the hammer housing.

### BACKGROUND OF THE INVENTION

1. Field of the Invention

The present invention relates to a percussion hammer and/or drill hammer according to the preamble of patent claim 1.

2. Description of the Related Art

Such a percussion hammer and/or drill hammer, designated “hammer” hereinafter, is known from DE 34 47 401 A1. According to this document, a part of a hammer housing in which there are situated, inter alia, a drive mechanism of the hammer and a percussion mechanism driven by the drive mechanism, is surrounded by a handle device that is realized as a handle cover. On the handle cover, handles are provided for the operator. A guide device made up of parallel rocker arms enables the handle cover to be displaced in linear fashion relative to the hammer housing when the operator presses the hammer, via the handles, against the stone that is to be processed. The parallel rockers are further connected to torsion springs in order to enable an oscillation damping for the handle cover.

A similar design is known from EP 0 949 988 B1. Here, axially behind a hammer housing a handle is provided that is guided via a guide device so as to be capable of linear movement relative to the hammer housing. The guide device is made up of a plurality of straight guide elements, each having an inner guide element and an outer guide element that surrounds the inner guide element at a distance, an elastic element being situated between the inner and the outer guide elements. In the working direction of the hammer, i.e., in the direction of the longitudinal or impact axis of the hammer, the elastic element has a greater elasticity than in a direction transverse to the longitudinal axis. In this way, the guide device enables a good vibration decoupling in the working direction, while the hammer can be held securely transversely to the working direction.

The described guide devices for the linear guiding of a handle or of a handle device relative to the hammer housing have proven to be effective in practice. Nonetheless, their realization requires additional constructive space, and an additional constructive expense resulting from an increased number of individual parts.

From U.S. Pat. No. 5,522,466, a hammer is known having a hammer housing and a handle device that is capable of movement relative to the hammer housing. On the hammer housing and on the handle device, elastic elements having oblique running surfaces are provided into which rolling elements are placed that are effective between the hammer housing and the handle device. The rolling elements are situated in the flow of force between the hammer housing and the handle device, and have a high elasticity in order to contribute to the vibration decoupling of the handle device.

### OBJECT OF THE INVENTION

The underlying object of the present invention is to indicate a percussion hammer and/or drill hammer having a guide device that is improved with respect to its guide action for the linear guiding of a handle device relative to a hammer housing, with simultaneous maintenance or improvement of vibration-damping properties, and a reduction of the constructive expense.

According to the present invention, this object is achieved by a percussion hammer and/or drill hammer according to patent claim 1. Advantageous further developments of the present invention are defined in the dependent claims.

A percussion hammer and/or drill hammer (“hammer”) according to the present invention is characterized in that the guide device has a rolling element device that is effective between the hammer housing and the handle device. The linear guiding that can be realized by the rolling element device makes it possible for the handle device to be reliably guided in a linear fashion relative to the hammer housing. Due to the fact that the rolling element device permits a definable, i.e., minimizable, friction effect between the handle device and the hammer housing, a vibration decoupling effect can be precisely set. With the use of a rolling element device, minimum friction values can be achieved that permit a good relative movement between the handle device and the hammer housing, so that the vibrations of the hammer housing are not transmitted to the handle device. In addition, it is possible to do away with the necessity of additionally providing completely separate guide elements for the guide device, as is the case in the prior art. Rather, both the handle device and the hammer housing can be used as components of the guide device, as is explained in more detail below.

In a preferred specific embodiment of the present invention, the guide device is provided laterally on the hammer housing in relation to the working direction (impact direction, main direction). In this way, an axial lengthening of the hammer, as seen for example in EP 0 949 988 B1, can be avoided. The lateral situation of the guide device does not result in a longer overall length of the hammer.

In another specific embodiment of the present invention, the handle device surrounds the hammer housing at a distance, so that an intermediate space is formed. The guide device is situated in the intermediate space between the hammer housing and the handle device. It therefore requires no additional housing and no additional constructive space, because an intermediate space is required in any case in order to permit the relative movement between the handle device and the hammer housing.

Advantageously, the rolling element device provides a defined spring characteristic transverse to the working direction, i.e., transverse to the longitudinal or impact direction. In this way, in addition to its linear mobility the handle device is also capable of movement transverse to the working direction, relative to the hammer housing. Of course, the transverse mobility should be significantly less than the longitudinal mobility in order to enable a good guiding of the hammer via the handle device or via the handle or handles. Also, in this way a small angular offset between the hammer housing and the handle device is possible, which in particular reduces the occurrence of transverse vibrations at the handle.

In a preferred specific embodiment of the present invention, the rolling element device has a plurality of rolling elements that are fastened to the handle device so as to be capable of rotation and to which there are allocated guide tracks provided on the outside of the hammer housing. Correspondingly, the rolling elements can roll on the guide tracks of the hammer housing, resulting in a very simple and robust linear guiding. Besides the guide tracks, which can be a component of the hammer housing, no additional constructive expense is required at the hammer housing. The rolling elements can be bought external parts that can easily be fastened to the inside of the handle device. Because the rolling elements, e.g. plastic rollers, that are commercially available are standardly already provided with bearings (slide bearings, roller bearings), the additional constructive expense can be kept low.

Advantageously, the rolling elements are each held against the guide tracks with a defined force by a spring device. The spring device can correspondingly be provided between each of the rolling elements and the handle device. In this way, it is possible to precisely set the degree of transverse mobility of the handle device relative to the hammer housing.

In an alternative or supplementary specific embodiment, the rolling elements have a defined spring characteristic, and thus a deformability in their radial direction. This is possible in particular if the rolling elements are made of an elastic plastic material, or have at least a running surface made of plastic. In this case, the rolling elements can be fastened directly to the handle device by means of bearings. Due to the elastic deformability of the rolling elements relative to the guide tracks on which the rolling elements roll, a sufficient transverse mobility of the handle device relative to the hammer housing is created.

Advantageously, a longitudinal spring device acting in the working direction is provided between the hammer housing and the handle device. The longitudinal spring device, which in addition to spring elements can also comprise damping elements, ensures a reliable vibration decoupling of the vibrations that occur during the operation of the hammer. In this way, it is achieved that the handle device, and in particular the handle provided on the handle device, transmits only slight vibrations to the operator. Suitable damping devices include passive elements (e.g. rubber cushions) as well as active or semi-active damping or decoupling devices.

Advantageously, the extension of the hammer housing in the working direction is greater than in a direction transverse to the working direction. In this way, the hammer has an oblong extension which favors the possible inclusion of a longitudinal guide between the handle device and the hammer housing.

In a particularly advantageous specific embodiment of the present invention, the hammer housing has, at least in a partial area of the housing extending in the working direction, an outer cross-sectional shape that does not change. It is then easy to provide the guide tracks in this partial area of the housing. In this way, for the hammer housing an extruded guide cylinder can for example be used whose uniform outer contour requires only slight processing in order to create the guide tracks. With corresponding manufacturing quality, even the guide tracks can be manufactured already during the extrusion, resulting in a considerable reduction in manufacturing costs. In the ideal case, in this way it is possible for the components of the guide device provided on the hammer housing to be capable of being manufactured without additional manufacturing expense.

Insofar as the partial area of the housing is the guide cylinder for the percussion mechanism, it is additionally possible to advantageously situate the percussion mechanism in the partial area of the housing.

In a preferred specific embodiment of the present invention, the outer cross-sectional shape of the hammer housing essentially has a prismatic shape. Here, one or more edges of the prism can be grasped by the rolling elements fastened to the handle device.

The handle device forms a kind of bearing element for the handle or handles. In a particularly advantageous further development of the present invention, the handle device is realized as a handle cover that surrounds at least a part of the hammer housing. The handle cover can surround the hammer housing in the manner of a hood or shell, as is known for example from DE 34 47 401 A1. The handles are then fastened externally to the handle cover, or are connected integrally to this cover.

These and additional advantages and features of the present invention are explained in more detail in the following, with the aid of the accompanying Figures.

### BRIEF DESCRIPTION OF THE DRAWINGS

FIG. 1 shows a percussion hammer and/or drill hammer (“hammer”) according to the present invention, in an overall side view;

FIG. 2 shows a view of the hammer from FIG. 1 in which a front covering of a handle cover has been removed; and

FIG. 3 shows a section along the line III-III in FIG. 2.

### DETAILED DESCRIPTION OF THE PREFERRED EMBODIMENT

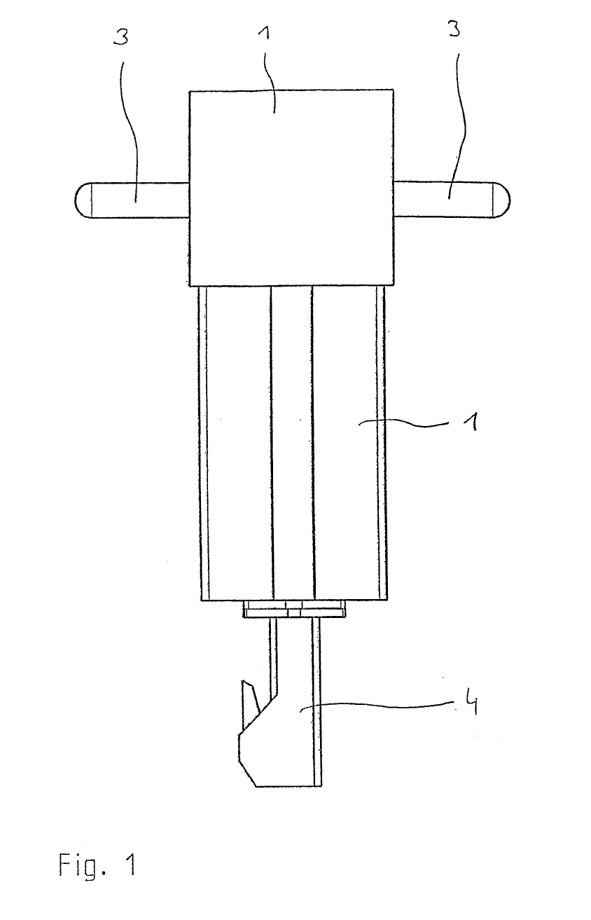

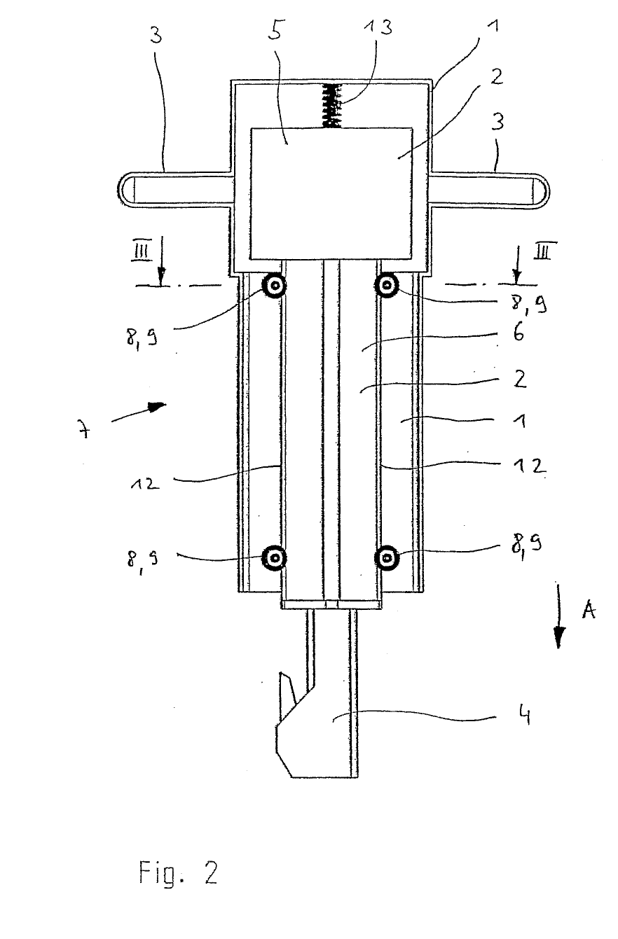

FIG. 1 shows a schematic side view of a percussion hammer and/or drill hammer according to the present invention, designated “hammer” in the following. FIG. 2 shows the same view, except that a front part of a handle cover 1 acting as a handle device has been removed, so that a schematically represented hammer housing 2 is visible in the interior.

Two handles 3 by which an operator can hold the hammer are attached to the outside of handle cover 1. At the lower end of handle cover 1 or of hammer housing 2, there opens a tool receptacle 4 in which a tool, e.g. a drill or a chisel, can be fastened in a known manner.

Such a design is already known in principle from DE 34 47 401 A1.

Hammer housing 2 has a drive housing 5 in which a motoric drive, a crank drive, etc., are provided in a known manner. Underneath drive housing 5, a percussion housing 6 is situated that is also part of hammer housing 2, and in which, from the drive movement produced by the motor, an impact movement is produced that is finally applied to the tool (not shown). The manner of functioning of such a hammer is known, and is therefore not described in more detail here.

Between handle cover 1 and hammer housing 2, which is made of plastic or metal, there is provided a guide device 7 that enables at least a linear guiding of handle cover 1 relative to hammer housing 2 in working direction A (impact direction, longitudinal direction) of the hammer, but preferably also enables a guiding of handle cover 1 relative to hammer housing 2 transverse to the working direction, and in a rotational direction about the percussion axis oriented in the working direction.

Guide device 7 has a rolling element device 8 comprising a plurality of rolling elements 9. In the example shown in FIG. 2, four rolling elements 9 can be seen.

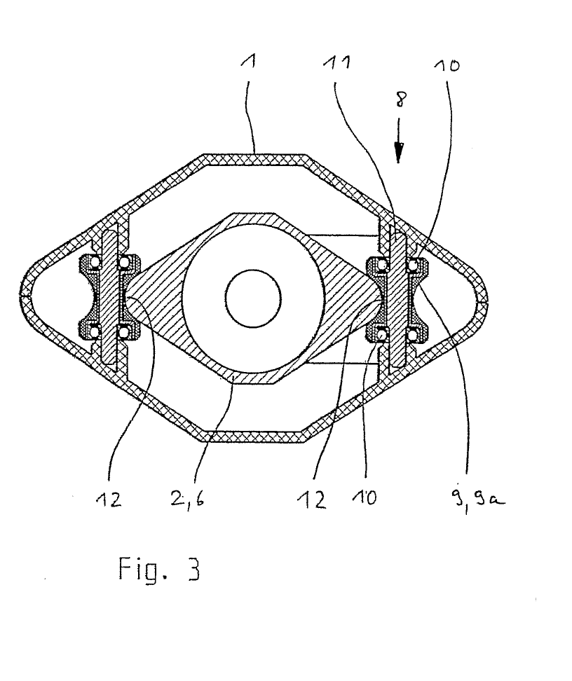

Rolling elements 9 are fastened to the inside of handle cover 1 so as to be capable of rotation. Rolling elements 9 can be externally bought parts. However, FIG. 3 shows a special manufacture of rolling elements 9. Rolling elements 9 shown there have plastic rollers 9a (e.g. elastomer rollers), each of which is mounted, via roller bearings 10, on an axle 11 held in handle cover 1.

Plastic rollers 9a roll over guide tracks 12 that run parallel to longitudinal direction A on the outside of the hammer housing. If hammer housing 2 or percussion mechanism housing 6 is an extruded profile, as is shown for example in FIGS. 2 and 3, guide tracks 12 can be created already in the extrusion process. A slight post-processing of guide tracks 12 may be necessary.

In order to achieve the best possible guiding between handle cover 1 and hammer housing 2, and in particular in order to ensure sufficient tipping stability, it is useful if hammer housing 2, in particular percussion mechanism housing 6 belonging to hammer housing 2, extends further in the longitudinal direction than in a direction transverse thereto. This can also be seen in FIG. 2. Rolling elements 9, which are arranged in pairs (upper pair and lower pair), then provide reliable protection against tipping, due to their relatively large axial spacing in relation to working direction A.

In a specific embodiment not shown in the Figures, rolling element devices 8 are each held on the inside of handle cover 1 by a spring device, which presses rolling elements 9 or plastic rollers 9a against guide tracks 12 with a defined force. In this way, the transverse mobility of handle cover 1 relative to hammer housing 2 can be set in a particularly precise manner.

Plastic rollers 9a can preferably also be made of an elastic material, so that they have a certain degree of deformability in their radial direction. In this way, it is possible for handle cover 1 also to be capable of movement transverse to hammer housing 2, against the spring action of the elastic material of plastic rollers 9a.

In order to improve the vibration decoupling of handle cover 1, in particular insulation of the vibrations occurring in hammer housing 2 during the operation of the hammer, a longitudinal spring device 13 is provided between handle cover 1 and hammer housing 2. Longitudinal spring device 13 comprises springs that can be pre-tensioned in such a way that handle cover 1 is capable of movement relative to hammer housing 2 only after the pre-tension effect has been overcome. Here, longitudinal spring device 13 ensures that handle cover 1 returns to its initial state relative to hammer housing 2 after the removal of load.

In addition, longitudinal spring device 13 can have damping elements that enable an adjustment of the damping effect. These damping elements can be passive, active, or semi-active dampers or decoupling devices already known from the prior art.

As can be seen in particular in FIG. 3, hammer housing 2, in particular percussion mechanism housing 6 belonging to hammer housing 2, can have a cross-section that has a prismatic design, in which the outer cross-sectional shape corresponds at least schematically to a prism.

As can also be seen in FIG. 3, it is then possible in a particularly advantageous manner to fashion guide tracks 12 precisely in the area of the edges of the prismatic shape. Of course, the edges need not be sharply drawn, but rather can have a cylindrical curvature, as is shown in FIG. 3. It is then possible for plastic rollers 9a to have a hollow chamfered outer contour with which they can grasp guide tracks 12, i.e., the “edges” of the prism, as is shown in FIG. 3. In this way, already with the two roller elements 9 shown in FIG. 3 it is possible to ensure that handle cover 1 is guided relative to hammer housing 2, and cannot deviate in a direction perpendicular to drive direction A.

Of course, guide tracks 12 can also, conversely, form recesses in which plastic rollers 9a roll in a laterally guided manner.

Conversely, it can also be useful to rotate rolling elements 9 with the lowest possible frictional values in order to ensure vibration isolation by means of other elements, in particular by means of longitudinal spring device 13.

Because almost exclusively roller motions, with as little sliding motion as possible, take place between handle cover 1 and hammer housing 2, the wear can be minimized. This is significant in particular because handle cover 1 is not sealed on its lower side, so that dust, dirt and moisture can enter there during operation of the hammer. Of course, however, rolling elements 8, and in particular their slide bearings or roller bearings 10, can be sealed in a commercially standard fashion. An additional sealing of the guide area, in particular of guide tracks 12, is however not required.

The specific embodiment has been explained on the basis of a hammer having a handle cover 1. Instead of handle cover 1, a differently constructed bearer can be used for handle or handles 3. For example, it is not necessary for the bearer to surround the hammer housing in the manner of a hood. Rather, an open construction, e.g. a cage construction, can also be used.

1. A percussion and/or drill hammer, comprising:
a hammer housing in which at least a part of a drive mechanism and a percussion mechanism are situated,
a handle device that is capable of movement relative to the hammer housing in a working direction (A), and on which at least one handle is provided, and
a guide device for the linear guiding of the handle device relative to the hammer housing,
wherein the guide device has a rolling element device that is effective between the hammer housing and the handle device, in which minimum friction values can be achieved that permit a good relative movement between the handle device and the hammer housing.

2. The percussion and/or drill hammer as recited in claim 1, wherein the guide device is provided laterally on the hammer housing in relation to the working direction (A).

3. The percussion and/or drill hammer as recited in claim 1, wherein
the handle device surrounds the hammer housing flat a distance, so that an intermediate space is formed, and in that
the guide device is situated in the intermediate space between the hammer housing and the handle device.

4. The percussion and/or drill hammer as recited in claim 1,
wherein the rolling element device ensures a defined spring characteristic transverse to the working direction (A) in such a way that the handle device is capable of movement relative to the hammer housing transverse to the working direction (A).

5. The percussion and/or drill hammer as recited in claim 1 wherein the rolling element device has rolling elements that are fastened to the handle device so as to be capable of rotation, and to which guide tracks provided on the outside of the hammer housing are allocated, or that are fastened to the hammer housing so as to be capable of rotation and to which guide tracks provided on the inside of the handle device (1).

6. The percussion and/or drill hammer as recited in claim 5, wherein the roller elements are each held against the guide tracks with a defined force by a spring device or by the elastic effect of the handle device.

7. The percussion and/or drill hammer as recited in claim 5, wherein the rolling elements have a defined spring characteristic, and thus a deformability in their radial direction.

8. The percussion and/or drill hammer as recited in claim 1 wherein a longitudinal spring device is provided that acts in the working direction (A) between the hammer housing and the handle device.

9. The percussion and/or drill hammer as recited in claim 1 wherein the extension of the hammer housing in the working direction (A) is greater than in a direction transverse to the working direction (A).

10. The percussion and/or drill hammer as recited in claim 1 wherein at least in a partial area of the housing extending in the working direction (A), the hammer housing has an outer cross-sectional shape that does not change.

11. The percussion and/or drill hammer as recited in claim 5 wherein the guide tracks are provided in the partial area of the housing.

12. The percussion and/or drill hammer as recited in claim 10, wherein the percussion mechanism is situated in the partial area of the housing.

13. The percussion and/or drill hammer as recited in claim 10, wherein the outer cross-sectional shape corresponds essentially to a prismatic shape, and in that at least one of the rolling elements grasps an edge of the prismatic shape.

14. The percussion and/or drill hammer as recited in claim 1 wherein the handle device is fashioned as a handle cover that surrounds at least a part of the hammer housing.
